(19) United States
(12) Patent Application Publication
(10) Pub. No.: US 2026/0234779 A1
(43) Pub. Date: Aug. 13, 2026

(54) 5000 SERIES PRINTED ALUMINUM ALLOYS

(71) Applicant: Apple Inc., Cupertino, CA (US)

(72) Inventors: Elizabeth Nicometo, Cupertino, CA (US); Maarten De Jong, Austin, TX (US); Cagatay Yanar, San Jose, CA (US); James A. Curran, Sunnyvale, CA (US); Ethan E. Currens, San Francisco, CA (US); Zechariah D. Feinberg, Austin, TX (US); Brian M. Gable, Monte Sereno, CA (US); Abhijeet Misra, Mountain View, CA (US); James A. Yurko, Saratoga, CA (US); Hossein Seyedrezai, San Francisco, CA (US); Herng-Jeng Jou, Lake Stevens, WA (US)

(21) Appl. No.: 19/537,001

(22) Filed: Feb. 11, 2026

Related U.S. Application Data
(60) Provisional application No. 63/757,039, filed on Feb. 11, 2025.

(51) Int. Cl. C22F 1/047; C22C 21/10; C22F 1/04

(52) U.S. Cl. CPC C22F 1/047; C22C 21/10; C22F 1/04

(57) ABSTRACT

The disclosure is directed to 5000 series aluminum alloys capable of being printed.

### PRIORITY

This patent application claims the benefit of U.S. Provisional Patent Application No. 63/757,039, entitled “5000 SERIES PRINTED ALUMINUM ALLOYS”, filed on Feb. 11, 2025, which is incorporated herein by reference in its entirety.

### FIELD

The disclosure generally relates to printable 5000 series aluminum alloys, precursors thereof, and methods of making the same.

### BACKGROUND

High strength and low density 3D printed metallic components with good cosmetic quality provide the ability to design lighter and thinner consumer electronics. Conventional wrought aluminum alloys exhibit hot cracking, while current commercial printed alloys suffer from poor cosmetic quality after anodizing.

5000 series aluminum alloys are particularly attractive for these applications. However, 3D printing conventional 5000 series aluminum alloys results in hot cracking, elongated grains, and other cosmetically unappealing effects rendering such alloys unusable for consumer purposes.

### SUMMARY

In a first aspect, the disclosure is directed to a printed 5000 series aluminum alloy. The printed 5000 series aluminum alloy includes 0.5 to 5.0 wt % Mg, 0.6-1.4 wt % Zr and Ti in combination, and the balance is aluminum and incidental impurities.

In some variations, the printed 5000 series aluminum alloy includes 1.5-2.3 wt % Mg. In further variations, the Zr is in an amount of 0.4-1.2 wt % Zr. In additional variations, the printed 5000 series aluminum alloy includes 0.6-1.4 wt % Zr and no Ti. In additional variations, the printed 5000 series aluminum alloy includes 0.55-0.75 wt % Zr and 0.55-0.75 wt % Ti.

In some variations, the printed 5000 series aluminum alloy includes less than or equal to 0.20 wt % Fe. In some further variations, the printed 5000 series aluminum alloy includes less than or equal to 0.10 wt % Mn. In some further variations, the printed 5000 series aluminum alloy includes less than or equal to 0.20 wt % Si.

In a second aspect, the printed 5000 series aluminum alloy includes 0.5 to 5.0 wt % Mg, 0.6-1.4 wt % Zr and Ti in combination, wherein the Zr and Ti are disposed in Al₃(Zr,Ti) inoculant particles. The balance is aluminum and incidental impurities. In some variations, the average Al₃(Zr,Ti) particle diameter is 50-600 nm. In still further variations, the yield strength is 100-200 MPa.

In a third aspect, the disclosure is directed to a method of making a printed 5000 series aluminum alloy. In some variations, a precursor composition including 0.5 to 5.0 wt % Mg, 0.6-1.4 wt % Zr and Ti in combination, with the balance is aluminum and incidental impurities, is disposed on a surface. In some variations, the precursor composition includes 1.0-1.3 wt % Zr and Ti in combination. The precursor composition is subject to laser radiation, thereby forming the printed 5000 series aluminum alloy. In some variations, the printed 5000 series aluminum alloy can be subjected to a heat treatment step. In additional variations, the average Al₃(Zr,Ti) particle diameter is 2-30 nm. In further variations, the yield strength is 280-380 MPa. In some variations, the Mg, Al, Zr, and Ti are in a powder form. In alternative variations, the Mg, Ti, and Al are in a powder form, and Zr is in ZrH₂ form.

In a fourth aspect, a printed part is formed of the printed aluminum alloy disclosed herein, and/or manufactured by a method disclosed herein.

The variations can be combined in any combination with any other variation, as described herein.

### BRIEF DESCRIPTION OF THE DRAWINGS

The disclosure will be readily understood by the following detailed description in conjunction with the accompanying drawings, wherein like reference numerals designate like structural elements. Various embodiments of the disclosure should not be construed as a complete recitation of the scope of the disclosure.

FIG. 1A depicts elongated grains in a conventional 5000 series aluminum alloy, according to an illustrative embodiment;

FIG. 1B depicts equiaxed grains in a conventional 5000 series aluminum alloy, according to an illustrative embodiment;

FIG. 2A depicts isocontour lines of a zirconium- and titanium-containing 5000 series aluminum alloy, according to an illustrative embodiment;

FIG. 2B depicts the predicted yield strength of a conventional 5000 series alloy as compared to sample alloys of the disclosure, according to an illustrative embodiment;

FIG. 2C depicts the yield strength (YS) of two different 5000 series aluminum alloys, according to an illustrative embodiment;

FIG. 3A depicts a conventional 5000 series alloy grains after 3D printing and solidification, according to an illustrative embodiment;

FIG. 3B depicts Al₃(Zr,Ti) inoculants in the 5000 series alloy grains, according to an illustrative embodiment;

FIG. 4A depicts as a first step the alloy can be a pre-alloyed powder including Al, Mg, and Zr and/or Ti, according to an illustrative embodiment;

FIG. 4B depicts an Al—Mg precursor powder containing ZrH₂ or TiH₂ particles, according to an illustrative embodiment;

FIG. 4C depicts a printed 5000 aluminum alloy containing Al₃(Zr,Ti) inoculants, according to an illustrative embodiment;

FIG. 4D depicts a printed 5000 aluminum alloy subject to aging and containing smaller Al₃(Zr,Ti) precipitants, according to an illustrative embodiment;

FIG. 5A depicts the predicted hot cracking susceptibility using the Kou et al. model, according to an illustrative embodiment;

FIG. 5B depicts the predicted hot cracking susceptibility using the Clyne and Davies model, according to an illustrative embodiment;

FIG. 5C depicts the predicted hot cracking susceptibility using the Easton et al. model, according to an illustrative embodiment;

FIG. 6A depicts the predicted temperature gradient during solidification in a 5000 series aluminum alloy having 1 wt % Mg and no Zr or Ti, according to an illustrative embodiment;

FIG. 6B depicts the predicted temperature gradient during solidification in a 5000 series aluminum alloy having 2 wt % Mg and no Zr or Ti, according to an illustrative embodiment;

FIG. 6C depicts the predicted temperature gradient during solidification in a 5000 series aluminum alloy having 3 wt % Mg and no Zr or Ti, according to an illustrative embodiment;

FIG. 6D depicts the predicted temperature gradient during solidification in a 5000 series aluminum alloy having 1 wt % Mg and 1.3 wt % Zr, according to an illustrative embodiment;

FIG. 6E depicts the predicted temperature gradient during solidification in a 5000 series aluminum alloy having 2 wt % Mg and 1.3 wt % Zr, according to an illustrative embodiment;

FIG. 6F depicts the predicted temperature gradient during solidification in a 5000 series aluminum alloy having 3 wt % Mg and 1.3 wt % Zr, according to an illustrative embodiment;

FIG. 7A depicts the ultimate tensile strength (UTS) of two different 5000 series aluminum alloys of the disclosure, according to illustrative embodiments; and

FIG. 7B depicts the ultimate tensile strength (UTS) of two different 5000 series aluminum alloys of the disclosure, according to illustrative embodiments.

### DETAILED DESCRIPTION

The disclosure may be understood by reference to the following detailed description, taken in conjunction with the drawings as described herein. It is noted that, for purposes of illustrative clarity, certain elements in various drawings may not be drawn to scale, may be represented schematically or conceptually, or otherwise may not correspond exactly to certain physical configurations of embodiments. All ranges described herein are inclusive of end points.

The phrase “additive manufacturing” is used interchangeably herein with the phrases “printing” and “3D printing.” As used herein, print and printing further refer to the various forms of additive manufacturing and include three-dimensional (3D) printing or 3D rapid prototyping, as well as sintering or melting/fusing technologies. During metal printing (i.e., 3 dimensional printing), alloy materials solidify very quickly over a large temperature range. As a result, a substantial amount of internal stress develops in the part that the alloy microstructure cannot accommodate. The disclosure provides 5000 series alloy compositions and microstructure that can accommodate that internal stress and not crack during printing.

The printable alloys of the disclosure can lead, in some variations, to a more uniform equiaxed and much smaller finer grain size that can accommodate stress and/or strain, thereby substantially reducing hot cracking during the printing process.

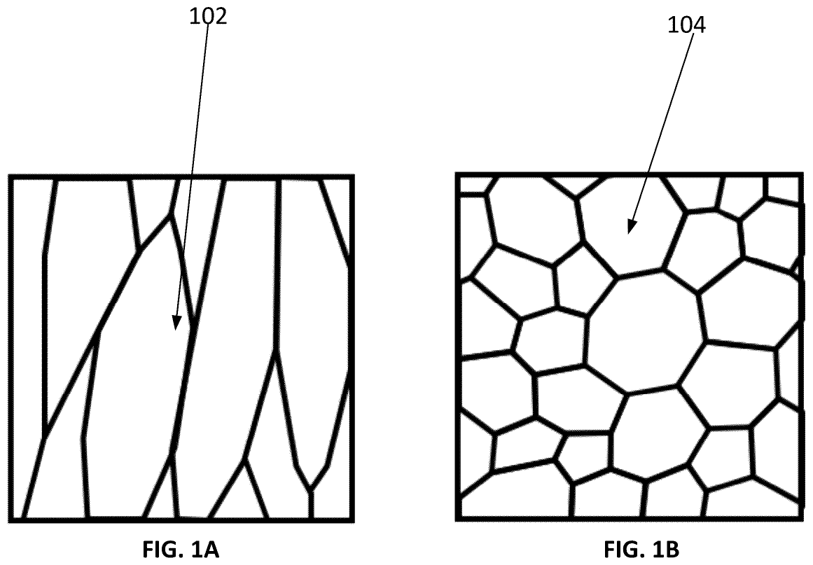

By way of example and not limitation, FIG. 1A depicts a conventional 5000 series aluminum alloy grains. The elongated grains 102 result in the presence of hot tear zones, which results in hot cracking during manufacture and otherwise poor anodization cosmetics. By contrast, FIG. 1B depicts equiaxed grains 104. In some embodiments, the equiaxed grain structure that can form during solidification is more resistant to hot tearing. Further, the equiaxed grains can provide good anodization cosmetics.

### Alloy Compositions

5000 series alloys (also referred to herein as “5k series alloys”) are based on a binary aluminum magnesium elemental composition. When printed, 5000 series aluminum alloys result in substantial hot tearing.

Hot cracking is reduced in 5k series alloys via the addition of Zr and/or Ti, which form particles in conjunction with Al, referred to herein as Al₃(Zr,Ti) inoculants (or alternatively as “Al₃(Zr,Ti) particles”). As referred to herein, the Al₃(Zr,Ti) inoculants can include Zr, Ti, or a combination of both. Al₃(Zr,Ti) inoculants promote reduced grain size and equiaxed grain structure.

Printability of 5k series alloys generally increases with increased Zr and Ti. If too little Zr and/or Ti are added, then the 5k series alloy is susceptible to hot cracking. Conversely, higher quantities of Zr and/or Ti result in reduced cosmetic appeal.

Accordingly, in some variations, the total combined Zr and Ti wt % in the 5000 series alloy is between 0.6 wt % total Zr and Ti and 1.4 wt % total Zr and Ti. In some variations, the total combined Zr and Ti wt % in the 5000 series alloy is between 1.0 wt % total Zr and Ti and 1.3 wt % total Zr and Ti.

In some variations, the 5000 series alloy includes a combination of Zr and Ti. In some such variations, the combination of Zr and Ti is at least 0.6 wt %. In some variations, the combination of Zr and Ti is at least 0.7 wt %. In some variations, the combination of Zr and Ti is at least 0.8 wt %. In some variations, the combination of Zr and Ti is at least 0.9 wt %. In some variations, the combination of Zr and Ti is at least 1.0 wt %. In some variations, the combination of Zr and Ti is at least 1.1 wt %. In some variations, the combination of Zr and Ti is at least 1.2 wt %. In some variations, the combination of Zr and Ti is at least 1.1 wt %. In some variations, the combination of Zr and Ti is at least 1.3 wt %. The upper and lower bounds can be selected individually, or together, in any combination.

In some variations in which the 5000 series alloy includes a combination of Zr and Ti, Zr having a minimum wt % and the remaining wt % being Ti. In some variations, Zr is at least 0.7 wt %. In some variations, Zr is at least 0.8 wt %. In some variations, Zr is at least 0.9 wt %. In some variations, Zr is at least 1.0 wt %. In some variations, Zr is at least 1.1 wt %. In some variations, Zr is at least 1.2 wt %. In some variations, Zr is at least 1.3 wt %. Likewise, in some variations, Zr is less than or equal to 1.4 wt %. In some variations, Zr is less than or equal to 1.3 wt %. In some variations, Zr is less than or equal to 1.2 wt %. In some variations, Zr is less than or equal to 1.1 wt %. In some variations, Zr is less than or equal to 1.0 wt %. In some variations, Zr is less than or equal to 0.9 wt %. In some variations, Zr is less than or equal to 0.8 wt %. In some variations, Zr is less than or equal to 0.7 wt %. The upper and lower bounds can be selected individually, or together, in any combination.

Similarly, in some variations, Ti is at least 0.7 wt %. In some variations, Ti is at least 0.8 wt %. In some variations, Ti is at least 0.9 wt %. In some variations, Ti is at least 1.0 wt %. In some variations, Ti is at least 1.1 wt %. In some variations, Ti is at least 1.2 wt %. In some variations, Ti is at least 1.3 wt %. Likewise, in some variations, Ti is less than or equal to 1.4 wt %. In some variations, Ti is less than or equal to 1.3 wt %. In some variations, Ti is less than or equal to 1.2 wt %. In some variations, Ti is less than or equal to 1.1 wt %. In some variations, Ti is less than or equal to 1.0 wt %. In some variations, Ti is less than or equal to 0.9 wt %. In some variations, Ti is less than or equal to 0.8 wt %. In some variations, Ti is less than or equal to 0.7 wt %. The upper and lower bounds can be selected individually, or together, in any combination.

In some variations, the 5000 series alloy includes Zr and no Ti. In these instances, the amount of Zr can be from 0.60 wt % to 1.40 wt %. In some such variations, Zr is at least 0.60 wt %. In some variations, Zr is at least 0.70 wt %. In some variations, Zr is at least 0.80 wt %. In some variations, Zr is at least 0.90 wt %. In some such variations, the amount of Zr is at least 1.00 wt %. In some variations, the amount of Zr is at least 1.10 wt %. In some variations, the amount of Zr is at least 1.20 wt %. In some variations, the amount of Zr is at least 1.30 wt %. In some variations, the amount of Zr is less than or equal to 1.40 wt %. In some variations, the amount of Zr is less than or equal to 1.30 wt %. In some variations, the amount of Zr is less than or equal to 1.20 wt %. In some variations, the amount of Zr is less than or equal to 1.10 wt %. In some variations, Zr is less than or equal to 1.00 wt %. In some variations, Zr is less than or equal to 0.90 wt %. In some variations, Zr is less than or equal to 0.80 wt %. In some variations, Zr is less than or equal to 0.70 wt %. The upper and lower bounds can be selected individually, or together, in any combination. For example, in a particular variation, the amount of Zr is between 0.60 wt % to 1.40 wt %.

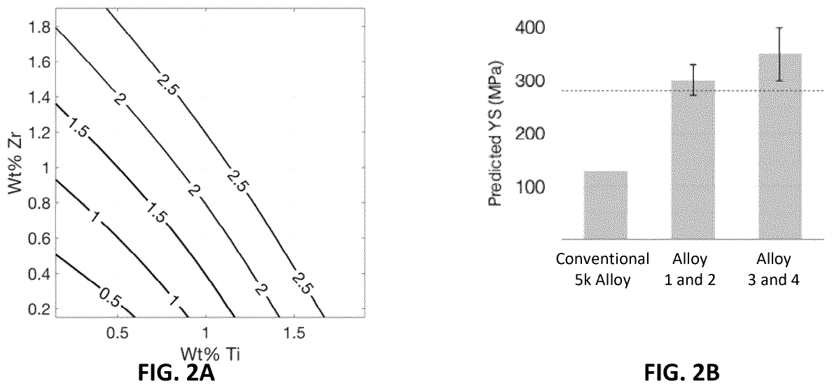

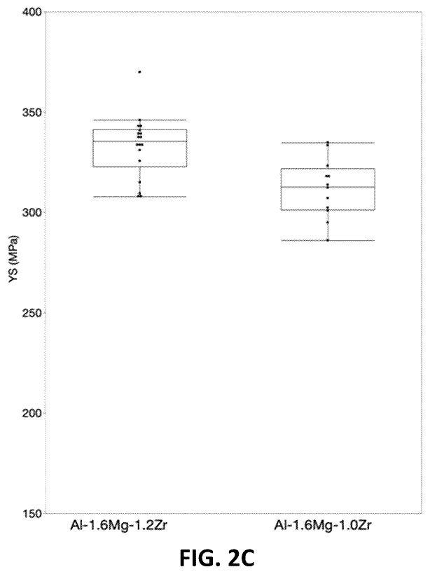

FIG. 2A depicts an Al₃(Zr, Ti) isocontour lines of zirconium and titanium in a 5000 series aluminum alloy. Isocontour lines are at a constant volume fraction of the Al₃(Zr,Ti) inoculant. In some variations, as the total quantity (volume fraction) of Al₃(Zr,Ti) inoculant increases, equiaxed grains become smaller, stress in the 5000 series alloy is reduced, the likelihood of hot tearing is reduced, and alloy printability improves. Moving along each isocontour line, the lattice matching increases with an increase in wt % of Zr and decrease in wt % Ti. The grain growth restriction increases as the wt % of Ti increases and wt % of Zr decrease.

Both zirconium and titanium improve printability of the Al alloy by forming inoculant particles Al₃(Zr, Ti) that match the aluminum matrix lattice. Ti diffusion ahead of the solidification front can provide a constitutional undercooling which promotes grain growth restriction.

TABLE 1

| | Al and | | | | | | | |
|---|---|---|---|---|---|---|---|---|
| | Incidental | Chemical Composition (wt %) | | | | | | |
| | Impurities | Mg | Zr | Fe | Cu | Si | Mn | Ti |
| Alloy 1 | Balance | 1.5-2.0 | 0.6-1.4 | <0.20 | <0.20 | <0.30 | <0.10 | <0.10 |
| Alloy 2 | Balance | 1.5-2.0 | 0.55-1.0 | <0.20 | <0.20 | <0.30 | <0.10 | 0-0.75 |
| Alloy 3 | Balance | 2.0-2.3 | 0.6-1.4 | <0.20 | <0.20 | <0.30 | <0.10 | <0.10 |
| Alloy 4 | Balance | 2.0-2.3 | 0.55-1.0 | <0.20 | <0.20 | <0.30 | <0.10 | 0-0.75 |

Table 1 depicts an example Al Alloys 1-4. Alloys 1 and 3 include zirconium only in the Al₃(Zr, Ti), while Alloys 2 and 4 include a combination of Zr and Ti in the Al₃(Zr, Ti) inoculant.

FIG. 2B depicts the predicted yield strength for a conventional 5k series alloy as compared to Alloys 1-4. Alloys 1 and 2 include 0.6-1.4 wt % Zr, while Alloys 3 and 4 include 0.55-0.75 wt % Zr and 0.55-0.75 wt % Ti. The increased yield strength is the result of increased Al(Zr, Ti)₃ particles, providing for increased strength at the border of alloy grains.

FIG. 2C depict the yield strength (YS) of two different aluminum alloys described herein: a first with 1.6 wt % Mg and 1.2 wt %, and a second with 1.6 wt % Mg and 1.0 wt % Zr. The yield strength of the alloy with 1.0 wt % Zr is on average less than the alloy with 1.2 wt % Zr, though within experimental error of each other.

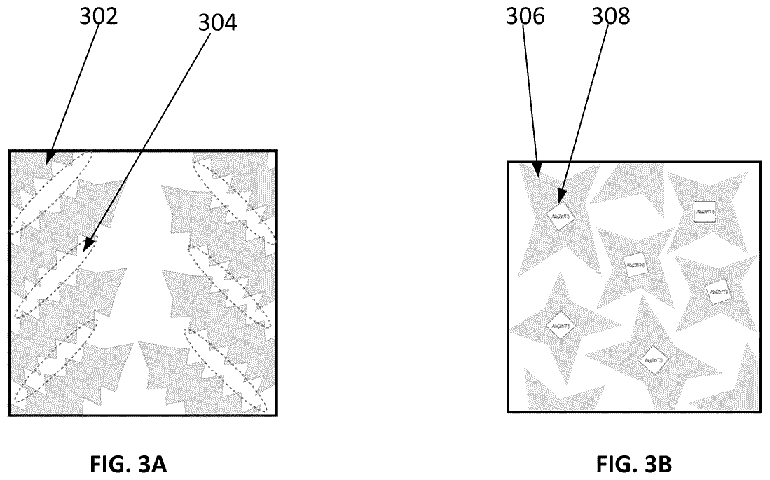

FIG. 3A depicts conventional 5k series alloy grains after 3D printing and solidification. The grains are elongated grains 302 result in the presence of hot tear zones 304. FIG. 3B depicts Al₃(Zr,Ti) inoculants 308 in the 5k series alloy grains 306 disclosed herein. The grains do not have hot tear zones, and as a result reduce susceptibility to hot cracking.

In some variations, there may be some free Zr not disposed in Al₃(Zr,Ti) inoculants and/or some free Ti not disposed in Al₃(Zr,Ti) inoculants.

### Magnesium in 5000 Series Aluminum Alloys

In some variations, the alloys have at least 0.50 wt % Mg. In some variations, the alloys have at least 1.00 wt % Mg. In some variations, the alloys have at least 1.50 wt % Mg. In some variations, the alloys have at least 2.00 wt % Mg. In some variations, the alloys have at least 2.50 wt % Mg. In some variations, the alloys have at least 3.00 wt % Mg. In some variations, the alloys have at least 3.50 wt % Mg. In some variations, the alloys have at least 4.00 wt % Mg. In some variations, the alloys have at least 4.50 wt % Mg. In some variations, the alloys have less than or equal to 5.00 wt % Mg. In some variations, the alloys have less than or equal to 4.50 wt % Mg. In some variations, the alloys have less than or equal to 4.00 wt % Mg. In some variations, the alloys have less than or equal to 3.50 wt % Mg. In some variations, the alloys have less than or equal to 3.00 wt % Mg. In some variations, the alloys have less than or equal to 2.50 wt % Mg. In some variations, the alloys have less than or equal to 2.00 wt % Mg. In some variations, the alloys have less than or equal to 1.50 wt % Mg. In some variations, the alloys have less than or equal to 1.0 wt % Mg.

The amount of Mg in the alloy can have a lower limit and/or an upper limit in any combination as described herein. In some particular examples, the alloys have 1.5-1.8 wt % Mg. In other particular examples, the alloys have 2.00-2.30 wt % Mg. In further particular examples, the alloys have 1.50-2.30 wt % Mg.

### Magnesium in Precursor Powders

Magnesium is present in both the final alloy, as well as the powder used in the process of printing the 5000 series aluminum alloys. Because some magnesium may volatilize during high temperature printing processes, the weight percent of magnesium in precursor powders can be increased relative to the amount in the 5000 series aluminum alloy. In some variations, the amount of Mg in powders can be 20-25% greater than in the 5000 series aluminum alloy.

In some variations, the powder has at least 0.50 wt % Mg. In some variations, the powder has at least 0.60 wt % Mg. In some variations, the powder has at least 0.70 wt % Mg. In some variations, the powder has at least 0.80 wt % Mg. In some variations, the powder has at least 0.90 wt % Mg. In some variations, the powder has at least 1.00 wt % Mg. In some variations, the powder has at least 1.10 wt % Mg. In some variations, the powder has at least 1.20 wt % Mg. In some variations, the powder has at least 1.30 wt % Mg. In some variations, the powder has at least 1.40 wt % Mg. In some variations, the powder has at least 1.50 wt % Mg. In some variations, the powder has at least 1.60 wt % Mg. In some variations, the powder has at least 1.70 wt % Mg. In some variations, the powder has at least 1.80 wt % Mg. In some variations, the powder has at least 2.00 wt % Mg. In some variations, the powder has at least 2.20 wt % Mg. In some variations, the powder has at least 2.40 wt % Mg. In some variations, the powder has at least 2.60 wt % Mg. In some variations, the powder has at least 2.80 wt % Mg. In some variations, the powder has at least 3.00 wt % Mg. In some variations, the powder has at least 3.50 wt % Mg. In some variations, the powder has at least 4.00 wt % Mg. In some variations, the powder has at least 4.50 wt % Mg.

In some variations, the powder has less than or equal to 5.00 wt % Mg. In some variations, the powder has less than or equal to 4.50 wt % Mg. In some variations, the powder has less than or equal to 4.00 wt % Mg. In some variations, the powder has less than or equal to 3.50 wt % Mg. In some variations, the powder has less than or equal to 3.00 wt % Mg. In some variations, the powder has less than or equal to 2.80 wt % Mg. In some variations, the powder has less than or equal to 2.60 wt % Mg. In some variations, the powder has less than or equal to 2.40 wt % Mg. In some variations, the powder has less than or equal to 2.20 wt % Mg. In some variations, the powder has less than or equal to 2.00 wt % Mg. In some variations, the powder has less than or equal to 1.90 wt % Mg. In some variations, the powder has less than or equal to 1.80 wt % Mg. In some variations, the powder has less than or equal to 1.70 wt % Mg. In some variations, the powder has less than or equal to 1.60 wt % Mg. In some variations, the powder has less than or equal to 1.50 wt % Mg. In some variations, the powder has less than or equal to 1.40 wt % Mg. In some variations, the powder has less than or equal to 1.30 wt % Mg. In some variations, the powder has less than or equal to 1.20 wt % Mg. In some variations, the powder has less than or equal to 1.10 wt % Mg. In some variations, the powder has less than or equal to 1.00 wt % Mg. In some variations, the powder has less than or equal to 0.90 wt % Mg. In some variations, the powder has less than or equal to 0.80 wt % Mg. In some variations, the powder has less than or equal to 0.70 wt % Mg. In some variations, the powder has less than or equal to 0.60 wt % Mg.

The amount of Mg in the powder can have a lower limit and/or an upper limit in any combination as described herein. In some particular examples, the powder has 1.5-1.8 wt % Mg. In other particular examples, the powder has 2.00-2.30 wt % Mg. In further particular examples, the powder has 1.50-2.30 wt % Mg. In additional examples, the powder has 0.50-5.00 wt % Mg.

### Iron

The amount of iron in the alloy is lower than a threshold quantity. Iron can add a darker and undesirable color to the 5000 series alloy. In the matrix that interact with the light in a way that reflects, the darker color from the anode and other elements that have a similar effect.

In some variations, the amount of Fe is less than or equal to 0.20 wt %. In some variations, the amount of Fe is less than or equal to 0.15 wt %. In some variations, the amount of Fe is less than or equal to 0.10 wt %. In some variations, the amount of Fe is less than or equal to 0.05 wt %. In some variations, the amount of Fe is less than or equal to 0.03 wt %. In some variations, the amount of Fe is less than or equal to 0.01 wt %. In some variations, the amount of Fe is at least 0.01 wt %. In some variations, the amount of Fe is at least 0.03 wt %. In some variations, the amount of Fe is at least 0.05 wt %. In some variations, the amount of Fe is at least 0.10 wt %. The amount of Fe can have a lower limit and/or an upper limit in any combination as described herein.

### Manganese

In some variations, the amount of Mn is less than or equal to 0.10 wt %. In some variations, the amount of Mn is less than or equal to 0.05 wt %. In some variations, the amount of Mn is less than or equal to 0.03 wt %. In some variations, the amount of Mn is less than or equal to 0.01 wt %. In some variations, the amount of Mn is at least 0.01 wt %. The amount of Mn can have a lower limit and/or an upper limit in any combination as described herein.

### Copper

Copper adds a yellowing aspect to the 5000 series alloy. As a result, the alloys have limited quantity of copper. In some variations, the amount of copper is less than or equal to 0.30 wt %. In some variations, the amount of copper is less than or equal to 0.25 wt %. In some variations, the amount of copper is less than or equal to 0.20 wt %. In some variations, the amount of copper is less than or equal to 0.15 wt %. In some variations, the amount of copper is less than or equal to 0.10 wt %. In some variations, the amount of copper is less than or equal to 0.05 wt %. In some variations, the amount of copper is less than or equal to 0.03 wt %. In some variations, the amount of copper is less than or equal to 0.01 wt %.

### Aluminum

The Al alloys can be described by various wt % of elements, as well as specific properties. An alloy composition can include a small amount of incidental impurities. The impurity elements can be present, for example, as a byproduct of processing and manufacturing. The balance of the 5000 series alloy is aluminum and incidental impurities. In various embodiments, an incidental impurity can be no greater than 0.05 wt % of any one additional element (i.e., a single impurity), and no greater than 0.10 wt % total of all additional elements (i.e., total impurities).

### Methods of Manufacture

The 5000 series alloys can be formed by additive manufacturing, or printing. Any type of additive manufacturing known in the art may be used. Non-limiting methods of printing can include laser powder bed fusion (LPBF), electron beam melting (EBM), and laser material deposition (LMD). In some particular methods, the additive manufacturing method is LPBF.

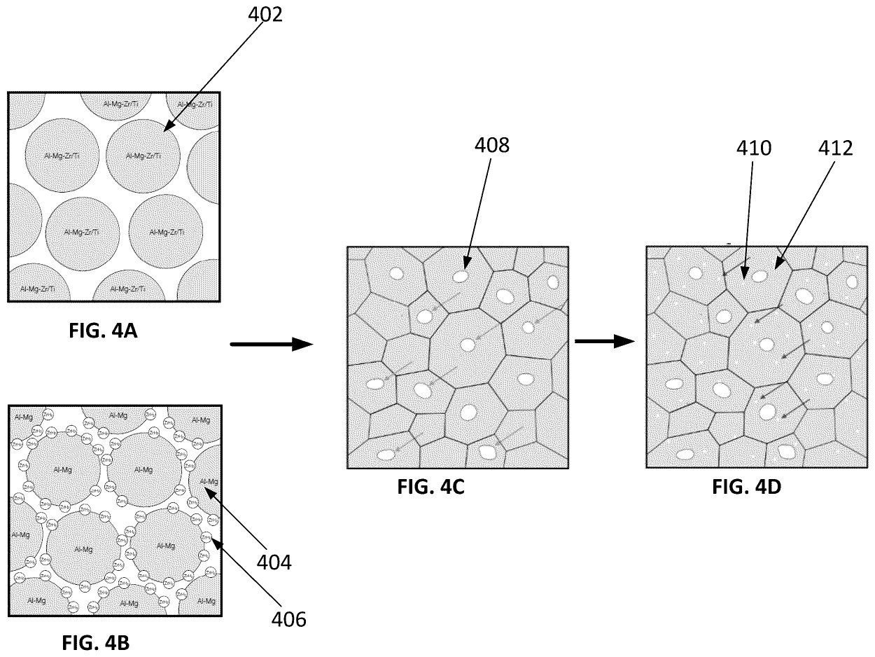

FIGS. 4A-4D depict a method of producing the submicron-grain powder. As depicted in FIG. 4A, the precursor can be precursor powder of particles 402 formed of Al, Mg, and Zr and/or Ti. Alternatively, as depicted in FIG. 4B, the precursor can be a powder formed of Al—Mg particles 404 and ZrH₂ particles 406. As depicted in FIG. 4C, the precursor powder is then subject to a printing step such as by laser powder bed fusion (LPBF). The printed 5000 series alloy contains submicron grain refining Al₃(Zr,Ti) inoculants 408s. With reference to FIG. 4D, the printed alloy is then subject to an aging step, forming smaller Al₃(Zr,Ti) precipitates 410. Precipitation of the smaller particles further strengthens the alloy by stabilizing the grains 412. The alloys are treated under T5 aging conditions.

With further reference to FIG. 4C, the printed refined grains include Al₃(Zr, Ti) particles 408 that nucleate multiple small grains. As a result, more grain boundaries are present than in the absence of nucleation points provided by the Al₃(Zr, Ti) particles. The grain boundaries themselves contribute to strengthening the alloy.

In some variations after the printing step depicted in FIG. 4C, the average diameter of the Al(Zr, Ti)₃ particles is less than or equal to 600 nm. In some variations after printing, the average diameter of the Al(Zr, Ti)₃ particles is less than or equal to 500 nm. In some variations after printing, the average diameter of the Al(Zr, Ti)₃ particles is less than or equal to 400 nm. In some variations after printing, the average diameter of the Al(Zr, Ti)₃ particles is less than or equal to 300 nm. In some variations after printing, the average diameter of the Al(Zr, Ti)₃ particles is less than or equal to 200 nm. the average diameter of the Al(Zr, Ti)₃ particles is at least 10 nm. In some variations, the average diameter of the Al(Zr, Ti)₃ particles is at least 25 nm. In some variations, the average diameter of the Al(Zr, Ti)₃ particles is at least 50 nm. In some variations, the average diameter of the Al(Zr, Ti)₃ particles is at least 100 nm. In some variations after printing, the average diameter of the Al(Zr, Ti)₃ particles is at least 150 nm. In some variations after printing, the average diameter of the Al(Zr, Ti)₃ particles is at least 200 nm. In some variations after printing, the average diameter of the Al(Zr, Ti)₃ particles is at least 250 nm. In some variations after printing, the average diameter of the Al(Zr, Ti)₃ particles is at least 300 nm. The average particle diameter can have a lower limit and/or an upper limit in any combination as described herein.

In some variations, the yield strength of the post-printed alloy is at least 50 MPa. In some variations, the yield strength of the post-printed alloy is at least 75 MPa. In some variations, the yield strength of the post-printed alloy is at least 90 MPa. In some variations, the yield strength of the post-printed alloy is at least 100 MPa. In some variations, the yield strength of the post-printed alloy is at least 125 MPa. In some variations, the yield strength of the post-printed alloy is at least 150 MPa. In some variations, the yield strength of the post-printed alloy is at least 175 MPa. In some variations, the yield strength of the post-printed alloy is at least 200 MPa. In some variations, the yield strength of the post-printed alloy is at least 225 MPa. In some variations, the yield strength of the post-printed alloy is less than or equal to 250 MPa. In some variations, the yield strength of the post-printed alloy is less than or equal to 225 MPa. In some variations, the yield strength of the post-printed alloy is less than or equal to 200 MPa. In some variations, the yield strength of the post-printed alloy is less than or equal to 175 MPa. In some variations, the yield strength of the post-printed alloy is less than or equal to 150 MPa. In some variations, the yield strength of the post-printed alloy is less than or equal to 125 MPa. In some variations, the yield strength of the post-printed alloy is less than or equal to 100 MPa. In some variations, the yield strength of the post-printed alloy is less than or equal to 75 MPa. For example, in some particular variations, the yield strength of the post-printed alloy is 100-200 MPa. The yield strength of the post-printed alloy can have a lower limit and/or an upper limit in any combination as described herein. With further reference to FIG. 4D, in some variations after aging, the average diameter of the Al(Zr, Ti)₃ particles 410 is at least 2 nm. In some variations after aging, the average diameter of the Al(Zr, Ti)₃ particles is at least 3 nm. In some variations after aging, the average diameter of the Al(Zr, Ti)₃ particles is at least 4 nm. In some variations after aging, the average diameter of the Al(Zr, Ti)₃ particles is at least 5 nm. In some variations after aging, the average diameter of the Al(Zr, Ti)₃ particles is at least 10 nm. In some variations after aging, the average diameter of the Al(Zr, Ti)₃ particles is less than or equal to 30 nm. In some variations after aging, the average diameter of the Al(Zr, Ti)₃ particles is less than or equal to 20 nm. In some variations after aging, the average diameter of the Al(Zr, Ti)₃ particles is less than or equal to 15 nm. In some variations after aging, the Al(Zr, Ti)₃ particles are less than or equal to 10 nm. In some variations after aging, the average diameter of the Al(Zr, Ti)₃ particles is less than or equal to 5 nm. The particle diameter can have a lower limit and/or an upper limit in any variation as described herein.

In some variations, the yield strength of the post-aging alloy is at least 200 MPa. In some variations, the yield strength of the post-aging alloy is at least 225 MPa. In some variations, the yield strength of the post-aging alloy is at least 250 MPa. In some variations, the yield strength of the post-aging alloy is at least 280 MPa. In some variations, the yield strength of the post-aging alloy is at least 300 MPa. In some variations, the yield strength of the post-aging alloy is at least 325 MPa. In some variations, the yield strength of the post-aging alloy is at least 350 MPa. In some variations, the yield strength of the post-aging alloy is less than or equal to 450 MPa. In some variations, the yield strength of the post-aging alloy is less than or equal to 425 MPa. In some variations, the yield strength of the post-aging alloy is less than or equal to 400 MPa. In some variations, the yield strength of the post-aging alloy is less than or equal to 380 MPa. In some variations, the yield strength of the post-aging alloy is less than or equal to 350 MPa. In some variations, the yield strength of the post-aging alloy is less than or equal to 325 MPa. In some variations, the yield strength of the post-aging alloy is less than or equal to 300 MPa. In some particular variations, the yield strength of the post-aging alloy is 280 MPa-380 MPa. The yield strength of the post-aging alloy can have a lower limit and/or an upper limit in any combination as described herein.

In some variations, the yield strength of the post-printed alloy is at least 50 MPa. In some variations, the yield strength of the post-printed alloy is at least 75 MPa. In some variations, the yield strength of the post-printed alloy is at least 90 MPa. In some variations, the yield strength of the post-printed alloy is at least 100 MPa. In some variations, the yield strength of the post-printed alloy is at least 125 MPa. In some variations, the yield strength of the post-printed alloy is at least 150 MPa. In some variations, the yield strength of the post-printed alloy is at least 175 MPa. In some variations, the yield strength of the post-printed alloy is at least 200 MPa. In some variations, the yield strength of the post-printed alloy is at least 225 MPa. In some variations, the yield strength of the post-printed alloy is less than or equal to 250 MPa. In some variations, the yield strength of the post-printed alloy is less than or equal to 225 MPa. In some variations, the yield strength of the post-printed alloy is less than or equal to 200 MPa. In some variations, the yield strength of the post-printed alloy is less than or equal to 175 MPa. In some variations, the yield strength of the post-printed alloy is less than or equal to 150 MPa. In some variations, the yield strength of the post-printed alloy is less than or equal to 125 MPa. In some variations, the yield strength of the post-printed alloy is less than or equal to 100 MPa. In some variations, the yield strength of the post-printed alloy is less than or equal to 75 MPa. For example, in some particular variations, the yield strength of the post-printed alloy is 100-200 MPa. The yield strength of the post-printed alloy can have a lower limit and/or an upper limit in any combination as described herein. With further reference to FIG. 4D, in some variations after aging, the average diameter of the Al(Zr, Ti)₃ particles 410 is at least 2 nm. In some variations after aging, the average diameter of the Al(Zr, Ti)₃ particles is at least 3 nm. In some variations after aging, the average diameter of the Al(Zr, Ti)₃ particles is at least 4 nm. In some variations after aging, the average diameter of the Al(Zr, Ti)₃ particles is at least 5 nm. In some variations after aging, the average diameter of the Al(Zr, Ti)₃ particles is at least 10 nm. In some variations after aging, the average diameter of the Al(Zr, Ti)₃ particles is less than or equal to 30 nm. In some variations after aging, the average diameter of the Al(Zr, Ti)₃ particles is less than or equal to 20 nm. In some variations after aging, the average diameter of the Al(Zr, Ti)₃ particles is less than or equal to 15 nm. In some variations after aging, the Al(Zr, Ti)₃ particles are less than or equal to 10 nm. In some variations after aging, the average diameter of the Al(Zr, Ti)₃ particles is less than or equal to 5 nm. The particle diameter can have a lower limit and/or an upper limit in any variation as described herein.

In some variations, the yield strength of the post-aging alloy is at least 200 MPa. In some variations, the yield strength of the post-aging alloy is at least 225 MPa. In some variations, the yield strength of the post-aging alloy is at least 250 MPa. In some variations, the yield strength of the post-aging alloy is at least 280 MPa. In some variations, the yield strength of the post-aging alloy is at least 300 MPa. In some variations, the yield strength of the post-aging alloy is at least 325 MPa. In some variations, the yield strength of the post-aging alloy is at least 350 MPa. In some variations, the yield strength of the post-aging alloy is less than or equal to 450 MPa. In some variations, the yield strength of the post-aging alloy is less than or equal to 425 MPa. In some variations, the yield strength of the post-aging alloy is less than or equal to 400 MPa. In some variations, the yield strength of the post-aging alloy is less than or equal to 380 MPa. In some variations, the yield strength of the post-aging alloy is less than or equal to 350 MPa. In some variations, the yield strength of the post-aging alloy is less than or equal to 325 MPa. In some variations, the yield strength of the post-aging alloy is less than or equal to 300 MPa. In some particular variations, the yield strength of the post-aging alloy is 280 MPa-380 MPa. The yield strength of the post-aging alloy can have a lower limit and/or an upper limit in any combination as described herein.

In some variations, the ultimate tensile strength of the 5000 series alloy is at least 200 MPa. In some variations, the ultimate tensile strength of the 5000 series alloy is at least 225 MPa. In some variations, the ultimate tensile strength of the 5000 series alloy is at least 250 MPa. In some variations, the ultimate tensile strength of the 5000 series alloy is at least 280 MPa. In some variations, the ultimate tensile strength of the 5000 series alloy is at least 300 MPa. In some variations, the ultimate tensile strength of the 5000 series alloy is at least 325 MPa. In some variations, the ultimate tensile strength of the 5000 series alloy is at least 350 MPa. In some variations, the ultimate tensile strength of the 5000 series alloy is less than or equal to 450 MPa. In some variations, the ultimate tensile strength of the 5000 series alloy is less than or equal to 425 MPa. In some variations, the ultimate tensile strength of the 5000 series alloy is less than or equal to 400 MPa. In some variations, the ultimate tensile strength of the 5000 series alloy is less than or equal to 380 MPa. In some variations, the ultimate tensile strength of the 5000 series alloy is less than or equal to 350 MPa. In some variations, the ultimate tensile strength of the 5000 series alloy is less than or equal to 325 MPa. In some variations, the ultimate tensile strength of the 5000 series alloy is less than or equal to 300 MPa. In some particular variations, the ultimate tensile strength of the 5000 series alloy is 280 MPa-380 MPa. The ultimate tensile strength of the 5000 series alloy can have a lower limit and/or an upper limit in any combination as described herein.

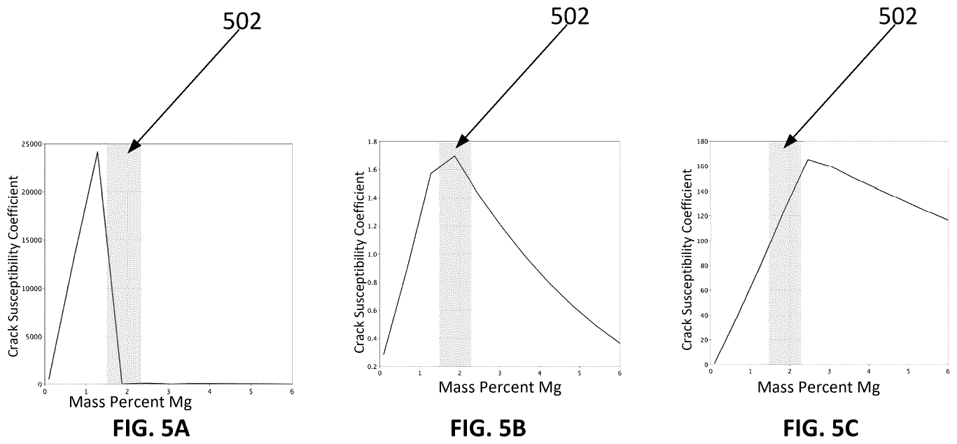

FIGS. 5A-5C depicts predicted hot cracking susceptibility, plotting the crack susceptibility coefficient as a function of magnesium percentage, using three separate models for predicting hot cracking of Al—Mg alloys with or without 1.3 wt % Zr. FIG. 5A depicts the Kou et al. model of hot cracking susceptibility. FIG. 5B depicts the Clyne and Davies model of hot cracking susceptibility. FIG. 5C depicts the Easton et al. model of hot cracking susceptibility. The magnesium ranges from 1.5-2.3 wt % (502), corresponding to the quantity of Mg in Alloys 1-4 in Table 1. In each instance, the model predicts hot tearing in the range of 1.5-2.3 wt % Mg, with and without 1.3 wt % Zr. Experimentally, in the absence of Zr or Ti, the 5000 series alloy is subject to hot tearing in printing applications (see Zhou et al., Additive Manufacturing (28) 485-496 (2019); Microstructure and mechanical properties of Zr-modified aluminum alloy T 5083 manufactured by laser powder bed fusion; T. W. Clyne and G. J. Davies: Br. Foundryman, 1981, vol. 74, pp. 65-73; S. Kou: Acta Materialia Volume 88, 15 Apr. 2015, pp. 366-374; M. A. Easton et. al.: Metallurgical and Materials Transactions A 3586 Vol. 45A, July 2014, all of which are incorporated herein by reference in their entirety).

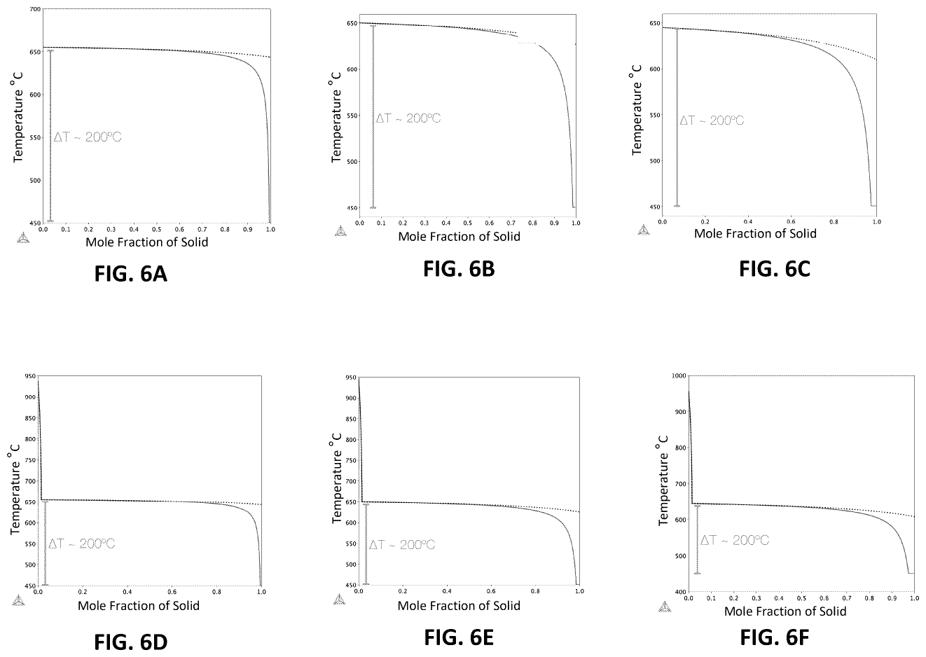

Conventional 5000 series alloys, introduction of elements such as zirconium reduce hot-tearing susceptibility, making the alloys printable. FIGS. 6A-6F depicts temperature gradient during solidification in a LPBF alloy. Larger temperature gradients can correspond to higher internal stress, which in turn can translate to higher crack susceptibility if there is no remaining liquid left to fill in the cracks at the end of solidification. Materials with large final solidification temperature gradients hot crack during solidification because of high internal stresses. However, the predicted final solidification temperature gradient is similar between non-printable traditional Al—Mg alloys (i.e., those without Zr) and the experimentally tested Al—Mg alloys (i.e., those having Zr).

FIGS. 6A, 6B, and 6C plot temperature as a function of mole fraction of solid for 5k series alloys having 1 wt % Mg, 2 wt % Mg, and 3 wt % Mg, respectively. In the absence of Zr, the 5000 series alloys are not printable as described herein. FIGS. 6D, 6E, and 6F plot temperature as a function of mole fraction of solid for 5k series alloys having 1 wt % Mg, 2 wt % Mg, and 3 wt % Mg, respectively, each including 1.3 wt % Zr, all printable alloys.

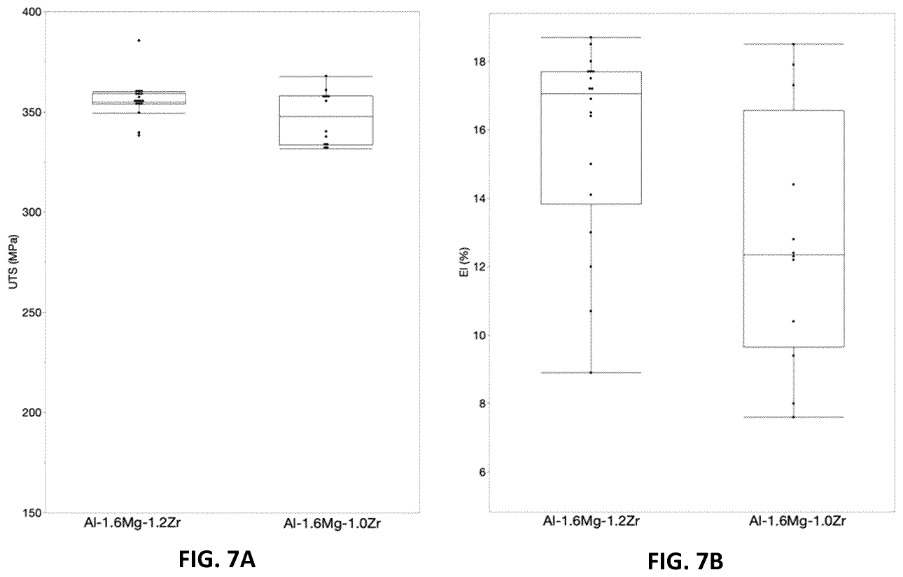

FIG. 7A the ultimate tensile strength (UTS) of two different aluminum alloys described herein: a first with 1.6 wt % Mg and 1.2 wt %, and a second with 1.6 wt % Mg and 1.0 wt % Zr. The ultimate tensile strength of the alloy with 1.0 wt % Zr is on average less than the alloy with 1.2 wt % Zr, though within experimental error of each other.

FIG. 7B the percent elongation of two different aluminum alloys described herein: a first with 1.6 wt % Mg and 1.2 wt %, and a second with 1.6 wt % Mg and 1.0 wt % Zr. The percent elongation is measured over a wide range for each alloy, and are within experimental error of each other.

In some variations, the 5000 series alloy has 1.50-2.00 wt % Mg, 0.90-1.10 wt % Zr, less than or equal to 0.10 wt % Mn, less than or equal to 0.20 wt % Fe, and less than or equal to 0.20 wt % Si. In some further variations, the 5000 series alloy has 1.50-1.90 wt % Mg, 0.95-1.05 wt % Zr, less than or equal to 0.05 wt % Mn, less than or equal to 0.15 wt % Fe, and less than or equal to 0.1 wt % Si.

In some variations, the 5000 series alloy has 1.30-2.10 wt % Mg, 0.90-1.10 wt % Zr, less than or equal to 0.10 wt % Mn, less than or equal to 0.20 wt % Fe, and less than or equal to 0.20 wt % Si. In some further variations, the 5000 series alloy has 1.50-1.90 wt % Mg, 1.15-1.25 wt % Zr, less than or equal to 0.05 wt % Mn, less than or equal to 0.15 wt % Fe, and less than or equal to 0.10 wt % Si.

In some variations, the 5000 series alloy has 1.50-2.00 wt % Mg, 1.10-1.30 wt % Zr, less than or equal to 0.10 wt % Mn, less than or equal to 0.20 wt % Fe, and less than or equal to 0.20 wt % Si. In some further variations, the 5000 series alloy has 1.50-1.90 wt % Mg, 1.15-1.25 wt % Zr, less than or equal to 0.05 wt % Mn, less than or equal to 0.15 wt % Fe, and less than or equal to 0.1 wt % Si.

In some variations, the 5000 series alloy has 1.30-2.10 wt % Mg, 1.10-1.30 wt % Zr, less than or equal to 0.10 wt % Mn, less than or equal to 0.20 wt % Fe, and less than or equal to 0.20 wt % Si. In some further variations, the 5000 series alloy has 1.50-1.90 wt % Mg, 1.15-1.25 wt % Zr, less than or equal to 0.05 wt % Mn, less than or equal to 0.15 wt % Fe, and less than or equal to 0.1 wt % Si.

In some variations, the 5000 series alloy has 3.00-4.00 wt % Mg, 0.90-1.10 wt % Zr, less than or equal to 0.10 wt % Mn, less than or equal to 0.20 wt % Fe, and less than or equal to 0.20 wt % Si. In some further variations, the 5000 series alloy has 3.50-4.00 wt % Mg, 0.90-1.10 wt % Zr, less than or equal to 0.05 wt % Mn, less than or equal to 0.15 wt % Fe, and less than or equal to 0.10 wt % Si.

In some variations, the 5000 series alloy has 3.20-4.00 wt % Mg, 0.90-1.10 wt % Zr, less than or equal to 0.10 wt % Mn, less than or equal to 0.20 wt % Fe, and less than or equal to 0.20 wt % Si. In some further variations, the 5000 series alloy has 3.40-3.80 wt % Mg, 0.95-1.05 wt % Zr, less than or equal to 0.05 wt % Mn, less than or equal to 0.15 wt % Fe, and less than or equal to 0.10 wt % Si.

### Color

Standard methods may be used for evaluation of cosmetics including color, gloss, and haze. The color of objects may be determined by the wavelength of light that is reflected or transmitted without being absorbed, assuming incident light is white light. The visual appearance of objects may vary with light reflection or transmission. Additional appearance attributes may be based on the directional brightness distribution of reflected light or transmitted light, commonly referred to glossy, shiny, dull, clear, haze, among others. The quantitative evaluation may be performed based on ASTM Standards on Color & Appearance Measurement or ASTM E-430 Standard Test Methods for Measurement of Gloss of High-Gloss Surfaces, including ASTM D523 (Gloss), ASTM D2457 (Gloss on plastics), ASTM E430 (Gloss on high-gloss surfaces, haze), and ASTM D5767 (DOI), among others. The measurements of gloss, haze, and DOI may be performed by testing equipment, such as Rhopoint IQ.

In some embodiments, color may be quantified by parameters L*, a*, and b*, where L* stands for light brightness, a* stands for color between red and green, and b* stands for color between blue and yellow. For example, high b* values suggest an unappealing yellowish color, not a gold yellow color. Values near zero in a* and b* suggest a neutral color. Low L* values suggest low brightness, while high L* value suggests high brightness. For color measurement, testing equipment, such as X-Rite Color i7 XTH, X-Rite Coloreye 7000 may be used. These measurements are according to CIE/ISO standards for illuminants, observers, and the L* a* b* color scale. For example, the standards include: (a) ISO 11664-1:2007 (E)/CIE S 014-1/E:2006: Joint ISO/CIE Standard: Colorimetry—Part 1: CIE Standard Colorimetric Observers; (b) ISO 11664-2:2007 (E)/CIE S 014-2/E:2006: Joint ISO/CIE Standard: Colorimetry—Part 2: CIE Standard Illuminants for Colorimetry, (c) ISO 11664-3:2012 (E)/CIE S 014-3/E:2011: Joint ISO/CIE Standard: Colorimetry—Part 3: CIE Tristimulus Values; and (d) ISO 11664-4:2008 (E)/CIE S 014-4/E:2007: Joint ISO/CIE Standard: Colorimetry—Part 4: CIE 1976 L* a* b* Colour Space.

In various aspects, the L* of the alloy disclosed herein is at least 85. In some instances, the L* of the alloy is at least 90.

The alloys disclosed herein can have neutral color. Neutral color refers to a* and b* that does not deviate beyond certain values close to 0. In various aspects, a* is not less than −0.5. In various aspects, a* is not less than −0.25. In various aspects, a* is not greater than 0.25. In various aspects, a* is not greater than 0.5. In further aspects, a* is not less than −0.5 and not greater than 0.5. In further aspects, a* is not less than −0.25 and not greater than 0.25.

In various aspects, b* is not less than −2.0. In various aspects, b* is not less than −1.75. In various aspects, b* is not less than −1.50. In various aspects, b* is not less than −1.25. In various aspects, b* is not less than −1.0. In various aspects, b* is not less than −0.5. In various aspects, b* is not less than −0.25. In various aspects, b* is not greater than 1.0. In various aspects, b* is not greater than 1.25. In various aspects, b* is not greater than 1.50. In various aspects, b* is not greater than 1.75. In various aspects, b* is not greater than 2.0. In various aspects, b* is not greater than 0.5. In various aspects, b* is not greater than 0.25. In further aspects, b* is not less than −1.0 and not greater than 1.0. In further aspects, b* is not less than −0.5 and not greater than 0.5.

In various embodiments, the alloys may be used as housings or other parts of an electronic device, such as, for example, a part of the housing or casing of the device. Devices can include any consumer electronic device, such as cell phones, desktop computers, laptop computers, and/or portable music players. The device can be a part of a display, such as a digital display, a monitor, an electronic-book reader, a portable web-browser, and a computer monitor. The device can also be an entertainment device, including a portable DVD player, DVD player, Blue-Ray disk player, video game console, or music player, such as a portable music player. The device can also be a part of a device that provides control, such as controlling the streaming of images, videos, sounds, or it can be a remote control for an electronic device. The alloys can be part of a computer or its accessories, such as the hard driver tower housing or casing, laptop housing, laptop keyboard, laptop track pad, desktop keyboard, mouse, and speaker. The alloys can also be applied to a device such as a watch or a clock.

In various further embodiments, more than one alloy can be used in a device casing. For example, an alloy having increased SCC resistance can be placed on the edges of a casing, while alloy without this difference is in the middle of the casing.

Having described several embodiments, it will be recognized by those skilled in the art that various modifications, alternative constructions, and equivalents may be used without departing from the spirit of the disclosure. Additionally, a number of well-known processes and elements have not been described in order to avoid unnecessarily obscuring the embodiments disclosed herein. Accordingly, the above description should not be taken as limiting the scope of the document.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall there between.

1. A printed 5000 series aluminum alloy comprising:
0.5 to 5.0 wt % Mg;
0.6-1.4 wt % Zr and Ti in combination;
and the balance is aluminum and incidental impurities.

2. The printed 5000 series aluminum alloy of claim 1 comprising 1.5-2.5 wt % Mg.

3. The printed 5000 series aluminum alloy of claim 1, comprising 0.4-1.2 wt % Zr.

4. The printed 5000 series aluminum alloy of claim 1, comprising 0.6-1.4 wt % Zr and no Ti.

5. The printed 5000 series aluminum alloy of claim 1, further comprising less than or equal to 0.20 wt % Fe.

6. The printed 5000 series aluminum alloy of claim 1, further comprising less than or equal to 0.10 wt % Mn.

7. The printed 5000 series aluminum alloy of claim 1, comprising 1.50-2.00 wt % Mg, 0.90-1.10 wt % Zr, less than or equal to 0.10 wt % Mn, less than or equal to 0.20 wt % Fe, and less than or equal to 0.20 wt % Si.

8. The printed 5000 series aluminum alloy of any claim 1, comprising 1.50-1.90 wt % Mg, 0.95-1.05 wt % Zr, less than or equal to 0.05 wt % Mn, less than or equal to 0.15 wt % Fe, and less than or equal to 0.1 wt % Si.

9. The printed 5000 series aluminum alloy of claim 1, comprising 1.30-2.10 wt % Mg, 0.90-1.10 wt % Zr, less than or equal to 0.10 wt % Mn, less than or equal to 0.20 wt % Fe, and less than or equal to 0.20 wt % Si.

10. The printed 5000 series aluminum alloy of claim 1, comprising 1.50-1.90 wt % Mg, 1.15-1.25 wt % Zr, less than or equal to 0.05 wt % Mn, less than or equal to 0.15 wt % Fe, and less than or equal to 0.10 wt % Si.

11. The printed 5000 series aluminum alloy of claim 1, comprising 1.50-2.00 wt % Mg, 1.10-1.30 wt % Zr, less than or equal to 0.10 wt % Mn, less than or equal to 0.20 wt % Fe, and less than or equal to 0.20 wt % Si.

12. The printed 5000 series aluminum alloy of claim 1, comprising 1.50-1.90 wt % Mg, 1.15-1.25 wt % Zr, less than or equal to 0.05 wt % Mn, less than or equal to 0.15 wt % Fe, and less than or equal to 0.1 wt % Si.

13. The printed 5000 series aluminum alloy of claim 1, comprising 1.30-2.10 wt % Mg, 1.10-1.30 wt % Zr, less than or equal to 0.10 wt % Mn, less than or equal to 0.20 wt % Fe, and less than or equal to 0.20 wt % Si.

14. The printed 5000 series aluminum alloy of claim 1, comprising 3.00-4.00 wt % Mg, 0.90-1.10 wt % Zr, less than or equal to 0.10 wt % Mn, less than or equal to 0.20 wt % Fe, and less than or equal to 0.20 wt % Si.

15. The printed 5000 series aluminum alloy of claim 1, comprising 3.50-4.00 wt % Mg, 0.90-1.10 wt % Zr, less than or equal to 0.05 wt % Mn, less than or equal to 0.15 wt % Fe, and less than or equal to 0.10 wt % Si.

16. The printed 5000 series aluminum alloy of claim 1, comprising 3.20-4.00 wt % Mg, 0.90-1.10 wt % Zr, less than or equal to 0.10 wt % Mn, less than or equal to 0.20 wt % Fe, and less than or equal to 0.20 wt % Si.

17. The printed 5000 series aluminum alloy of claim 1, comprising 3.40-3.80 wt % Mg, 0.95-1.05 wt % Zr, less than or equal to 0.05 wt % Mn, less than or equal to 0.15 wt % Fe, and less than or equal to 0.10 wt % Si.

18. The printed 5000 series aluminum alloy of claim 1, wherein an average grain aspect ratio of less than 1.2.

19. The printed 5000 series aluminum alloy of claim 1, wherein the Zr and the Ti are disposed in Al₃(Zr,Ti) inoculants particles.

20. The printed 5000 series aluminum alloy of claim 4, wherein the Zr is disposed in Al₃(Zr) inoculants particles.

21. The printed 5000 series aluminum alloy of claim 19, wherein an average Al₃(Zr,Ti) particle diameter is 100-600 nm.

22. The printed 5000 series aluminum alloy of claim 21, wherein the yield strength is 100-200 MPa.

23. The printed 5000 series aluminum alloy of claim 19, wherein the average Al₃(Zr,Ti) particle diameter is 2-30 nm.

24. The printed 5000 series aluminum alloy of claim 23, wherein the yield strength is 280-380 MPa.

25. A method of making a printed 5000 series aluminum alloy comprising:
depositing a precursor composition on a surface, the precursor composition comprising 0.5 to 5.0 wt % Mg, 0.6-1.4 wt % Zr and Ti in combination, and the balance is aluminum and incidental impurities; and
subjecting the precursor composition to laser radiation, thereby forming the printed 5000 series aluminum alloy according to claim 1.

26. A printed part formed of the printed 5000 series aluminum alloy of claim 1.
